(19) United States
(12) Patent Application Publication
(10) Pub. No.: US 2026/0194897 A1
(43) Pub. Date: Jul. 9, 2026

(54) COUNTERMEASURE SUPPORT SYSTEM, MANUFACTURING SYSTEM, AND COUNTERMEASURE SUPPORT METHOD

(71) Applicant: Hitachi, Ltd., Tokyo (JP)

(72) Inventors: Hiromichi ENDOH, Tokyo (JP); Takashi OGURA, Tokyo (JP); Noritaka MATSUMOTO, Tokyo (JP)

(21) Appl. No.: 19/440,797

(22) Filed: Jan. 6, 2026

(30) Foreign Application Priority Data
Jan. 9, 2025 (JP) 2025-003441

(51) Int. Cl. G05B 23/02

(52) U.S. Cl. CPC G05B 23/0275; G05B 23/0243

(57) ABSTRACT

A countermeasure support system includes a countermeasure plan generation device and a determination device, in which the countermeasure plan generation device includes an input unit that generates event information regarding an event that occurs in a target system that is a target for which a countermeasure plan of the countermeasure plan generation device is to be created, a system model generation unit that generates a system model expressing an operation of the target system, a scenario generation unit that generates an event scenario of the event for the target system by using the event information and the system model, a countermeasure plan generation unit that generates a countermeasure plan for the event by using the event scenario, and an operation prediction unit that predicts an operation of the target system using the system model, the event scenario, and the countermeasure plan.

### CLAIM OF PRIORITY

The present application claims priority from Japanese Patent application serial no. 2025-003441, filed on January 9, 2025, the content of which is hereby incorporated by reference into this application.

### BACKGROUND OF THE INVENTION

### 1. Field of the Invention

The present invention relates to a countermeasure support system, a manufacturing system, and a countermeasure support method for supporting a countermeasure against an abnormality in an information processing system.

### 2. Description of the Related Art

Information (IT) systems and control (OT) systems (hereinafter referred to as systems) used in social infrastructure, industry, and the like play a large role in society. Meanwhile, when the systems stop, not only the convenience of life but also the influence on human life and environment may be large. Therefore, the systems are required to cope with abnormalities such as disasters and cyberattacks and continue business. Naturally, it is desirable that the means and timing for dealing with the abnormality are also selected so as to have as little influence as possible on the continuation of the business.

In addition, social infrastructure and industries often form a so-called supply chain in which a plurality of intermediate products/services are passed before final products/services are generated from raw materials/services, and the generation is performed by different business operators. When the abnormality as described above occurs in any of the business operators participating in the supply chain, the supply of the final product/service may be affected. Therefore, it is desirable to take measures against the abnormality in consideration of the influence on the entire supply chain.

JP 2023-154864 A is cited as a prior art related to the above problem. This publication discloses “an information processing device including: a satisfaction level evaluation unit that evaluates a satisfaction level of a system requirement for a combination on a basis of evaluation target information indicating the combination of security countermeasure technologies to be evaluated, system requirement information indicating a system requirement that is an operational requirement of the target system, and influence information indicating an influence of each security countermeasure technology included in the combination on the target system, and generates satisfaction level information indicating the satisfaction level of the system requirement of the combination; an achievement level evaluation unit that evaluates an achievement level of the combination on a basis of achievement information indicating an introduction achievement of a security countermeasure technology included in the combination for a system that is a same system requirement as the target system, calculated on a basis of a security design case, and generates achievement level information indicating the achievement level of the combination; and a recommendation level evaluation unit that evaluates a recommendation level of the combination on a basis of the achievement level information and the satisfaction level information.” (claim 1).

### SUMMARY OF THE INVENTION

In the case of JP 2023-154864 A, when viewed as a supply chain, it is necessary to consider not only the influence on the availability of the target system alone but also the influence of a cooperation destination (for example, a supply destination business operator of a material or a component) caused by the influence, and it cannot be said that the above-described prior art can sufficiently solve the influence.

An object of the present invention is to support selection of a countermeasure and timing of implementation when an abnormality occurs at a supplier in a supply chain, which reduces the influence of the abnormality itself and the implementation of countermeasures on the supply of products and services, as well as the influence of the influence on a business of a supply destination.

The present invention includes a plurality of means for solving the above problems, and an example thereof is a countermeasure support system including a countermeasure plan generation device and a determination device. The countermeasure plan generation device includes an input unit that generates event information regarding an event that occurs in a target system that is a target for which a countermeasure plan of the countermeasure plan generation device is to be created, a system model generation unit that generates a system model expressing an operation of the target system, a scenario generation unit that generates an event scenario of the event for the target system by using the event information and the system model, a countermeasure plan generation unit that generates a countermeasure plan for the event by using the event scenario, an operation prediction unit that predicts an operation of the target system using the system model, the event scenario, and the countermeasure plan, a first influence evaluation unit that evaluates a first influence on the target system using an operation prediction result by the operation prediction unit, and a first transmission unit that transmits the countermeasure plan created by the countermeasure plan generation unit and a first evaluation result by the first influence evaluation unit to the determination device. Moreover, the determination device includes a reception unit that receives the countermeasure plan and the first evaluation result transmitted by the first transmission unit, a second influence evaluation unit that uses the countermeasure plan received by the reception unit and the first evaluation result to evaluate a second influence of the first influence on a cooperation destination system that cooperates with the target system, and a second transmission unit that transmits a second evaluation result by the second influence evaluation unit to the countermeasure plan generation device.

According to the present invention, the countermeasure plan generation device uses the scenario of the event that occurs in the target system and the countermeasure plan for the event to evaluate an influence of the event and its countermeasure on a coping ability of the target system and whether the target system can continue to respond. In addition, the determination device evaluates the influence of the evaluation result on the cooperation destination system.

As a result, when an abnormality occurs in the supplier in the supply chain described above, it is possible to evaluate the influence of the abnormality itself and the implementation of the countermeasure on the supply of products and services, and further, the influence of these influences on the business of the supply destination. Accordingly, the problem in the present invention can be solved by determining the plan of the countermeasure so as to reduce the influence on the business of the supply destination.

### BRIEF DESCRIPTION OF THE DRAWINGS

FIG. 1 is an overall configuration of a countermeasure support system according to a first embodiment of the present invention;

FIG. 2 is a hardware configuration diagram of a countermeasure plan generation device according to the first embodiment of the present invention;

FIG. 3 is a software functional diagram of the countermeasure plan generation device according to the first embodiment of the present invention;

FIG. 4A is a diagram illustrating an example of a system model according to the first embodiment of the present invention;

FIG. 4B is a diagram for describing an example of a system model according to the first embodiment of the present invention;

FIG. 5A is a diagram illustrating an example of attack information according to the first embodiment of the present invention;

FIG. 5B is a diagram for describing an example of the attack information according to the first embodiment of the present invention;

FIG. 6 is a diagram for explaining an example of a countermeasure plan according to the first embodiment of the present invention;

FIG. 7 is a hardware configuration diagram of a determination device according to the first embodiment of the present invention;

FIG. 8A is a software functional diagram of the determination device according to the first embodiment of the present invention;

FIG. 8B is an example of a user interface according to the first embodiment of the present invention;

FIG. 9 is an overall configuration of a countermeasure support system according to a second embodiment of the present invention;

FIG. 10 is an overall configuration of a countermeasure support system according to a third embodiment of the present invention; and

FIG. 11 is an overall configuration of a countermeasure support system according to a fourth embodiment of the present invention.

### DESCRIPTION OF THE PREFERRED EMBODIMENTS

Hereinafter, embodiments will be described with reference to the drawings. Note that, in the description of each embodiment, it is assumed that various functions and means constituting the embodiment are implemented by software. However, unless otherwise specified, the various functions and means can be realized by an electric circuit or an electronic circuit, and an integrated circuit incorporating the electric circuit or the electronic circuit, a microcomputer or a processor, and an arithmetic device similar thereto, a ROM, a RAM, a flash memory, a hard disk, an SSD, a memory card, an optical disk, and a storage device similar thereto, a bus, a network, and a communication device similar thereto, and the combination of the above and other related devices, and the present invention can be realized in any implementation mode.

### First Embodiment

In the present embodiment, a security countermeasure support system for a product manufacturing system will be described.

### Description of Overall Configuration

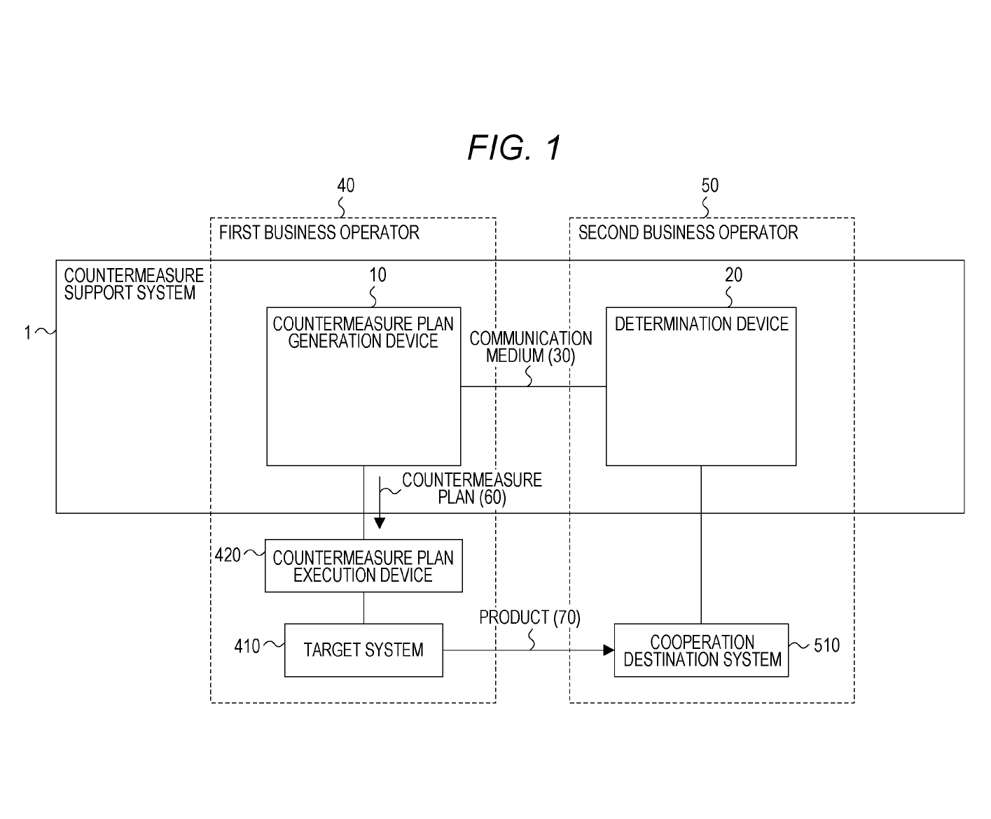

FIG. 1 is an overall configuration diagram illustrating a relationship between a supplier of a product and a supply destination business operator, and a security countermeasure support system according to the present embodiment.

A first business operator 40 is a supplier of a product, and operates a target system 410, which is a product manufacturing system, to manufacture a product 70 from a raw material or an intermediate product (neither is illustrated) and supply the product to the second business operator 50.

The target system 410 includes a manufacturing facility and a control system thereof (neither is illustrated). The first business operator 40 further includes a countermeasure plan generation device 10 and a countermeasure plan execution device 420.

The second business operator 50 operates a cooperation destination system 510, which is a manufacturing system different from the first business operator 40, to manufacture a product (not illustrated) from the product 70 supplied from the first business operator 40 and other raw materials and intermediate products (neither is illustrated). The second business operator 50 further includes a determination device 20.

The countermeasure support system 1 includes the countermeasure plan generation device 10, the determination device 20, and a communication medium 30 such as a communication network that connects these devices. The communication medium 30 may be wired or wireless, and may be, for example, a direct connection by a communication cable or the like, short-range wireless communication, a public line such as the Internet, VPN, or the like.

The countermeasure plan generation device 10 generates a countermeasure plan 60 that is an implementation plan of a security countermeasure applied to the target system 410. The countermeasure plan execution device 420 reflects the countermeasure plan 60 in the target system 410.

The countermeasure plan execution device 420 can be realized by, for example, a patch server that distributes a patch (update program) of the countermeasure content designated in the countermeasure plan 60 to the target system 410 at a designated time. In addition, the countermeasure plan execution device may be a display device that simply instructs a worker to apply the patch having the designated content at the designated time. In addition, the countermeasure plan execution device 420 may be configured so that the countermeasure plan generation device 10 includes a processing unit that executes a function corresponding to the countermeasure plan execution device.

The determination device 20 evaluates the influence of implementation of the countermeasure plan generated by the countermeasure plan generation device 10 on the cooperation destination system 510. Then, the determination device determines whether the countermeasure plan is acceptable to the second business operator, and notifies the countermeasure plan generation device 10 of the determination result via the communication medium 30.

### Description of Countermeasure Plan Generation Device

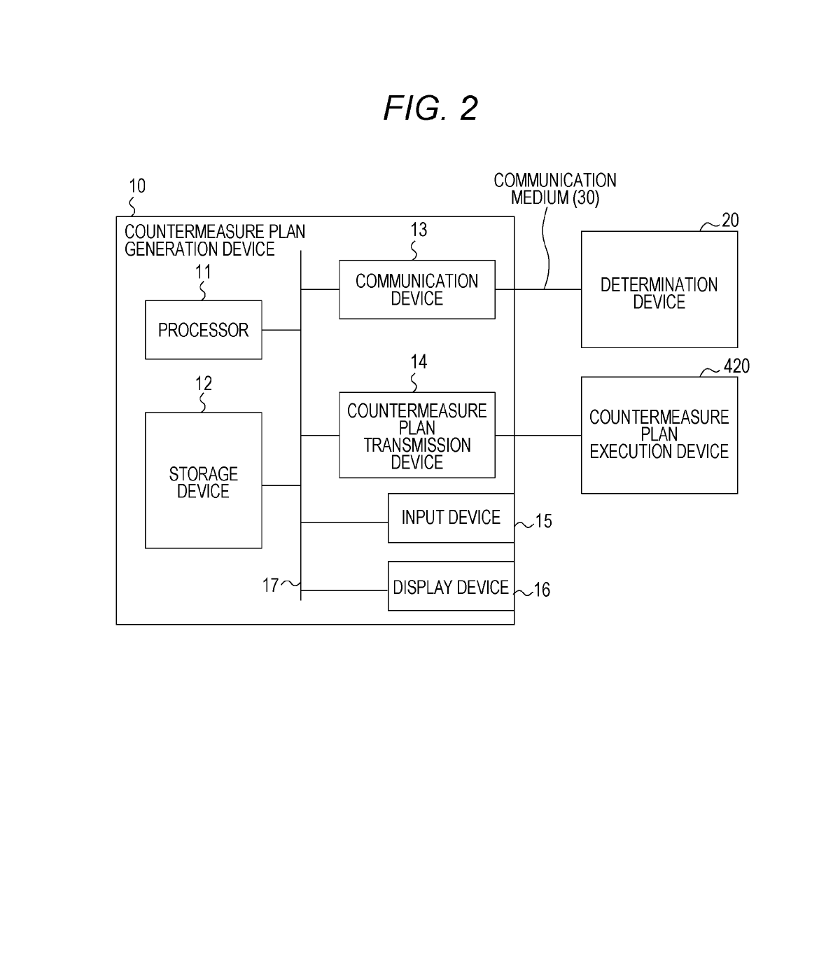

Next, a detailed configuration of the countermeasure support system 1 will be described. FIG. 2 illustrates an example of a hardware configuration of the countermeasure plan generation device 10.

The countermeasure plan generation device 10 includes a processor 11, a storage device 12, a communication device 13, a countermeasure plan transmission device 14, an input device 15, a display device 16, and a bus 17 that interconnects these devices. The countermeasure plan generation device 10 can be implemented by using, for example, a personal computer (PC) or a server.

The storage device 12 stores programs and data including various software functions to be described later, and the processor 11 reads and executes the programs and data. In addition, in the process, the processor 11 accesses the communication device 13 and the countermeasure plan transmission device 14, and transmits various types of information and notifications between the determination device 20 and the countermeasure plan execution device 420. Note that the countermeasure plan transmission device 14 may be implemented by the function of the communication device 13 and connected to the countermeasure plan execution device 420 via the communication medium 30.

The input device 15 is, for example, a keyboard, a mouse, or the like, and is used by a user (operator, attendant, or the like) of the target system 1 to operate the countermeasure plan generation device 10 and input information necessary for the operation. The display device 16 is, for example, a display device or the like, and presents information such as an operation progress and an error of the countermeasure plan generation device 10 to the user. Furthermore, the input device 15 and the display device 16 may have an integrated structure, for example, a touch panel type display device or the like.

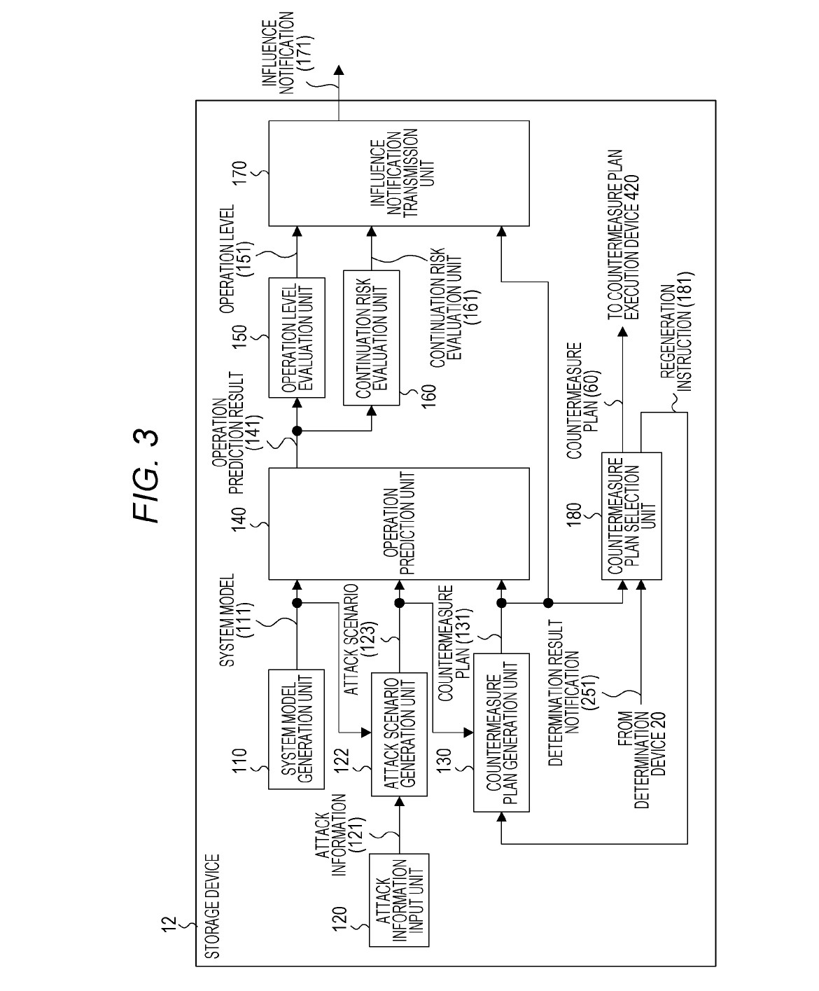

FIG. 3 illustrates configurations of various software functions stored in the storage device 12.

The system model generation unit 110 converts the system configuration and the operation specification of the target system 410 into a system model 111 for reproducing or approximating the normal operation of the target system 410. The system model 111 is expressed by, for example, a mathematical model such as an automaton or a Petri net, a rule such as a state transition table or a diagram, a combination thereof, and a program obtained by converting them into an executable program.

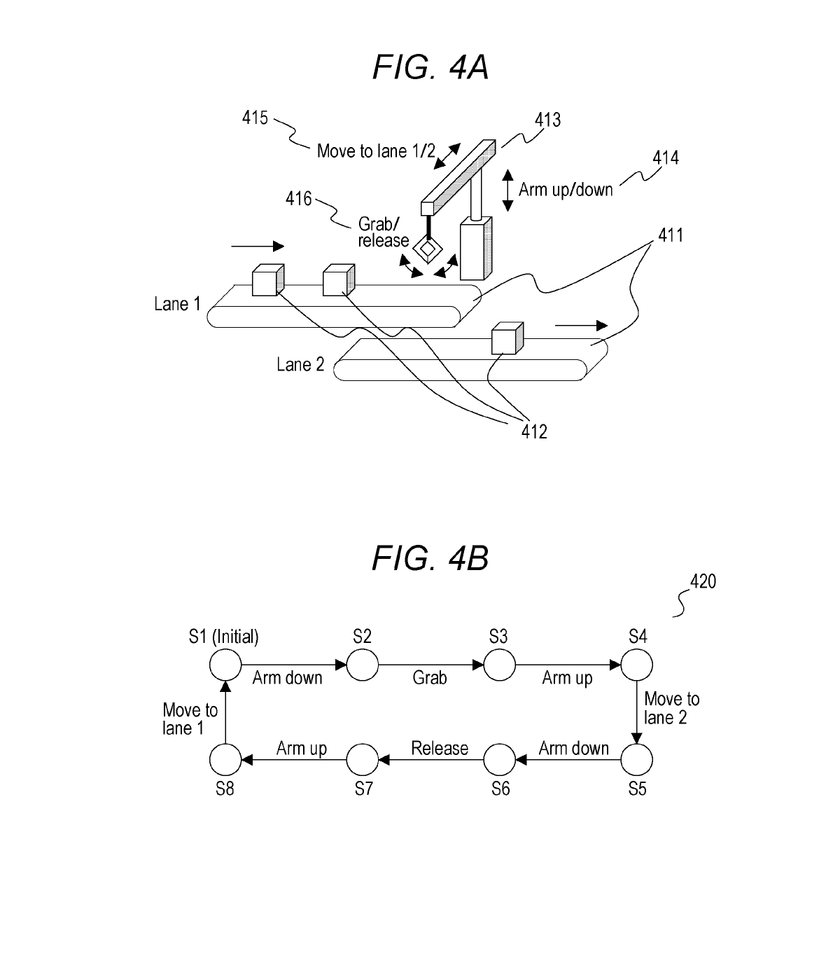

As an example of the system model 111, for example, a robot arm 413 that performs an operation of transferring a load 412 between two conveyors 411 as illustrated in FIG. 4A is assumed. When the robot arm 413 has respective operation functions of up/down movement 414, movement between lanes 1/2 415, and grabbing/releasing of the load 416, the system model 111 of the robot arm 413 can be expressed by a state transition diagram 420 as illustrated in FIG. 4B. Note that, in an actual robot arm, one operation may include a plurality of control operations, such as position detection and servo control for moving the arm in accordance with the gripping position of the load, and torque control for adjusting the gripping force. Therefore, the system model may be more complicated, or another operation model may be nested inside.

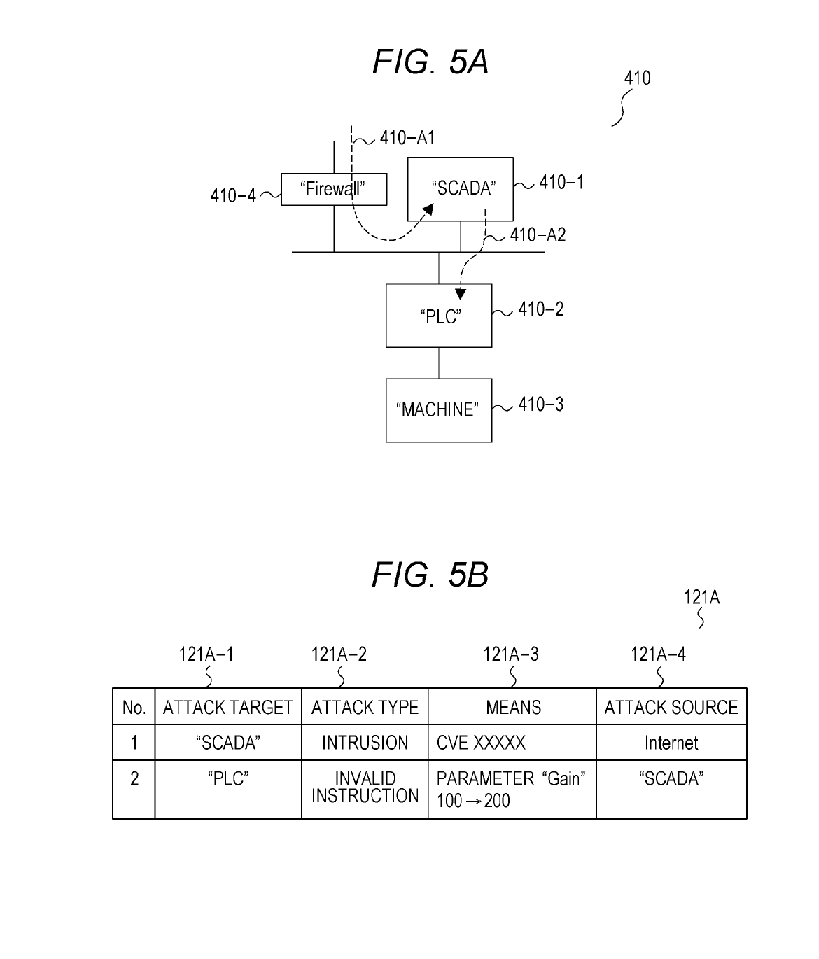

An attack information input unit 120 generates attack information 121 for reproducing a cyberattack as an event that may occur (or has occurred) on the target system 410, and inputs the attack information to an attack scenario generation unit 122 to be described later. The attack information 121 includes information such as the type of attack and the type of the device to be attacked. As an example of the attack information 121, for example, it is assumed that the target system 410 has the device configuration illustrated in FIG. 5A. Here, a device 410-1 “SCADA” is a monitoring and operation terminal, a device 410-2 “PLC” is a control device, a device 410-3 “MACHINE” is a facility to be controlled, and a device 410-4 “Firewall” is a firewall.

In this system 410, in a case where the “SCADA” 410-1 is subjected to an intrusion by an attacker via the Internet as a first stage (410-A1), and the intruding attacker further performs a series of cyberattacks of transmitting an invalid control parameter to the “PLC” 410-2 as a second stage (410-A2), the attack information 121 can be expressed by, for example, a table format 121A as illustrated in FIG. 5B.

In this example, contents of the attack are listed in order of occurrence in each row of the table, and an attack target 121A-1, an attack source 121A-4, an attack type 121A-2, and a specific means 121A-3 thereof are described in each row. Note that the column “CVE XXXXX” of the means 121A-3 in the first line (No. 1) represents the registration number of the vulnerability used in the attack, and the column “PARAMETER “Gain”100→200” of the means 121A-3 in the second line (No. 2) represents the content of the transmitted invalid control parameter. In this embodiment, “Gain” which is a control parameter is changed from 100 to 200.

Furthermore, the attack information input unit 120 can be implemented as, for example, an interface function that prompts the user to input the information via the input device 15, or a function of acquiring information corresponding to the target system 410 from vulnerability information disclosed on the Internet or the like.

On the basis of the system model 111 and the attack information 121, the attack scenario generation unit 122 generates an attack scenario 123 in which the occurrence and expansion of the cyberattack on the target system 410 and the influence thereof are expressed in time series. In the attack scenario 123, for example, a situation in which a certain device on the target system 410 performs an unintended operation due to a cyberattack generated in the device, a situation in which an attack spreads to another device due to the unintended operation of the device, and the like are expressed in time series. The difference between the attack scenario 123 and the attack information 121 is that in the attack scenario 123, information such as the influence and damage occurring as a result of the attack and the time when these events occur is reproduced on the basis of the configuration and operation of the target system 410. As a method of generating such an attack scenario, for example, a technique called an attack scenario analysis method, a simulator, a digital twin, or the like can be used. The attack scenario analysis method is, for example, a method of referring to information regarding a device configuration or a software configuration of the target system and information regarding content of a known vulnerability, and predicting an influence to be generated in a device and a system subjected to an attack, an attack propagation range, and the like when an attack using the vulnerability in the system occurs.

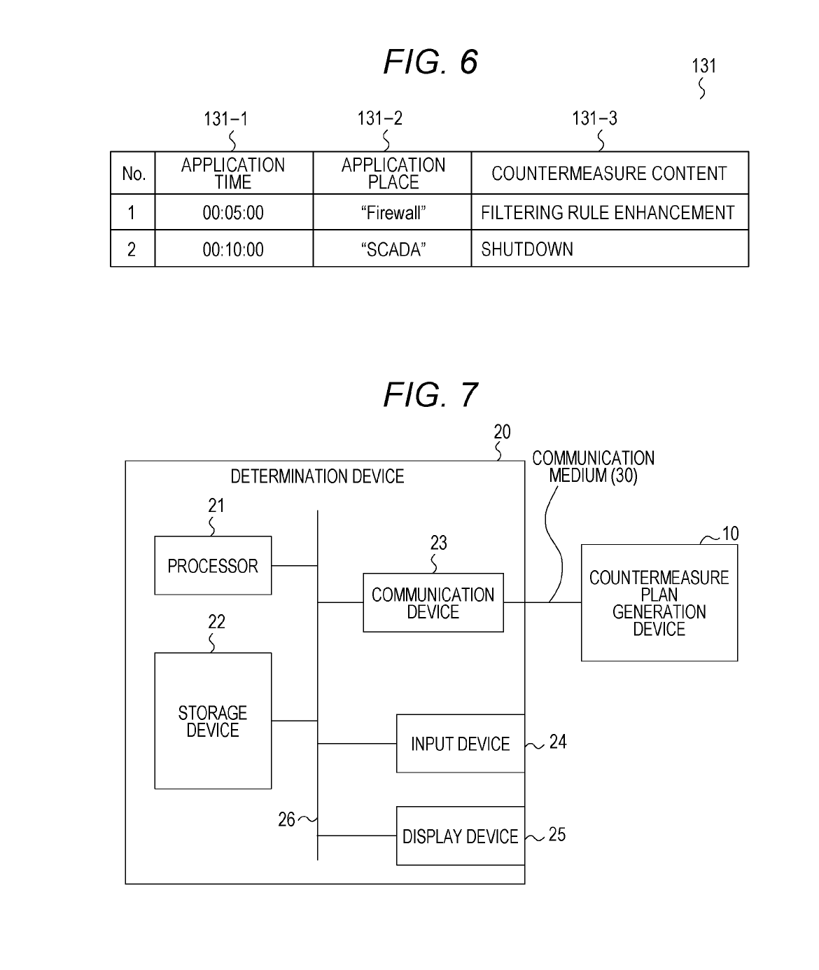

The countermeasure plan generation unit 130 generates a countermeasure plan 131 for coping with the cyberattack occurring on the target system 410 on the basis of the instruction of the user via the input device 15 and the content of the attack scenario 123. The countermeasure plan 131 is defined with respect to one or a plurality of security countermeasures, and includes at least one of an implementation content of the countermeasure, an application place of the countermeasure, and an application time (time (absolute time or elapsed time from occurrence of attack)). The countermeasure plan 131 is, for example, in a table format as illustrated in FIG. 6, and can describe, in each row, an application time (relative time) 131-1 of a countermeasure to be executed, an application place 131-2, and a countermeasure content 131-3 in chronological order. In this example, as the first countermeasure (No. 1), the rule of the “Firewall” is corrected five minutes after the attack occurs to enhance the filtering, and as the next countermeasure (No. 2), a countermeasure is intended to stop the “SCADA” subjected to the attack further five minutes later to prevent the progress of the attack.

In addition, when receiving the regeneration instruction 181, the countermeasure plan generation unit 130 generates a new countermeasure plan that is different from the countermeasure plan generated so far in at least either the countermeasure content or the application time. Details will be described later.

The operation prediction unit 140 predicts the operation of the target system 410 using the system model 111, the attack scenario 123, and the countermeasure plan 131 as inputs. The operation prediction unit 140 is configured using a simulator, an emulator, a digital twin, and technologies similar thereto.

The prediction of the operation by the operation prediction unit 140 reproduces the normal operation of the target system 410 using the system model 111 at the initial stage of the prediction processing, for example. Then, the operation of the system is modified at the time instructed using the attack scenario 123 to simulate the occurrence of the cyberattack. For example, a part of the system model 111 is modified to simulate the operation of malware. Furthermore, the prediction is performed by a method of restoring the operation of the system at the time instructed using the countermeasure plan 131. When the reproduction accuracy of the operation prediction unit 140 is sufficiently high, the malware code itself may be executed by a processor to reproduce a result of the execution. The operation prediction unit 140 outputs a log of the operation progress of the target system 410 as an operation prediction result 141.

An operation level evaluation unit 150 extracts the operation status of the manufacturing facility included in the operation prediction result 141 to acquire the passage of time of the production capacity (production amount) of the product 70 by the first business operator 40 as an operation level 151. For example, when events (including not only events caused by cyberattacks but also events associated with security countermeasures) such as stop or operation delay of a device that controls a production facility are recorded in the operation prediction result 141, the operation level evaluation unit 150 evaluates the production capacity contributed by the device in which the event has occurred and the decrease in the production amount according to the process handled by the device, and reflects the evaluation result in the operation level 151. The time to be reflected in the decrease in the production amount is earlier when the process handled by the device whose operation is stopped is the downstream process, and is later as the process approaches the upstream process.

A continuation risk evaluation unit 160 extracts the damage event to the control function of the target system 410 from the operation prediction result 141, evaluates the damage event as the degree of influence on the business continuity of the first business operator 40 from the content and the occurrence place, and outputs a continuation risk 161 as the possibility that the operation level may fall below a predetermined threshold. Here, the damage event refers to a loss of a function, information, or control right caused by a cyberattack, and includes, for example, destruction of an OS environment or control data by malware or the like (as a prominent example, ransomware), control right deprivation using a backdoor, a remote operation server, or the like.

When the damage event occurs, the production capacity of the first business operator 40 irreversibly decreases, and the business continuity is impaired in a case where the operation level falls below a predetermined threshold. Furthermore, the damage event also includes a risk of propagation and expansion of a cyberattack to other systems, and for example, in a case where the cooperation system 510 of the second business operator 50 is network-connected to the target system 410, the security risk also occurs in the cooperation system 510.

An influence notification transmission unit 170 estimates the influences of the cyberattack on the target system 410 and the security countermeasure corresponding thereto, and transmits the estimated influence as an influence notification 171 to the determination device 20 via the communication medium 30. The influence notification 171 includes the operation level 151 and continuation risk 161 as indexes of the influence.

Note that, in the above description, a plurality of countermeasure plans 131 can be associated with one attack scenario. In this case, the operation prediction result 141 corresponding to each of the countermeasure plans 131 is output from the operation prediction unit 140, and a plurality of sets of the operation level 151 and the continuation risk 161 are also generated. Therefore, the influence notification transmission unit 170 generates the influence notification 171 including an identifier (not illustrated) associated with the countermeasure plan 131 for each set of the operation level 151 and the continuation risk 161.

The countermeasure plan selection unit 180 determines the adoption or non-adoption of the countermeasure plan 131 on the basis of a determination result notification 251 transmitted from the determination device 20, and outputs the adopted countermeasure plan 60 to the countermeasure plan execution device 420. Details will be described in <Description (2) of Countermeasure Plan Generation Device> described later.

### Description of Determination Device

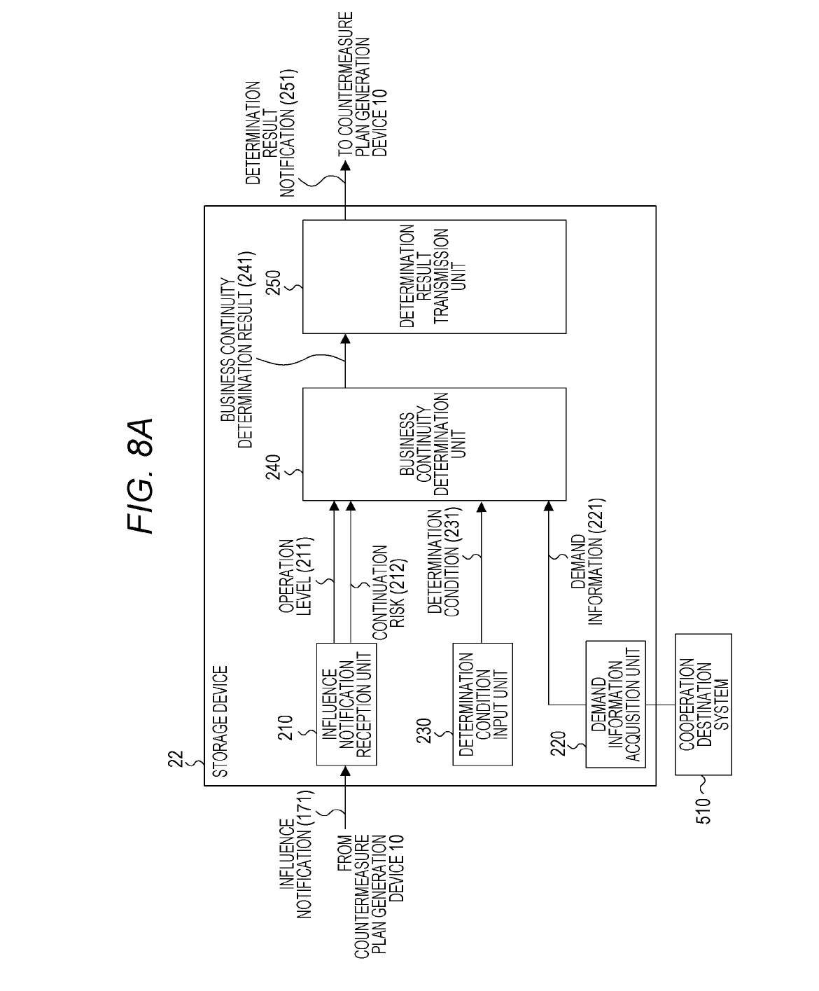

FIG. 7 illustrates an example of a hardware configuration of the determination device 20.

The determination device 20 has a configuration similar to that of the countermeasure plan generation device, and includes a processor 21, a storage device 22, a communication device 23, an input device 24, a display device 25, and a bus 26 that connects these devices to each other. The determination device 20 can be realized by using, for example, a PC or a server.

The storage device 22 stores programs and data including various software functions to be described later, and the processor 21 reads and executes the programs and data. In addition, in the process, the processor 21 accesses the communication device 23 and transmits various types of information and notifications to and from the countermeasure plan generation device 10. The input device 24 is, for example, an input device such as a keyboard or a mouse, and the display device 25 is, for example, a display device or the like.

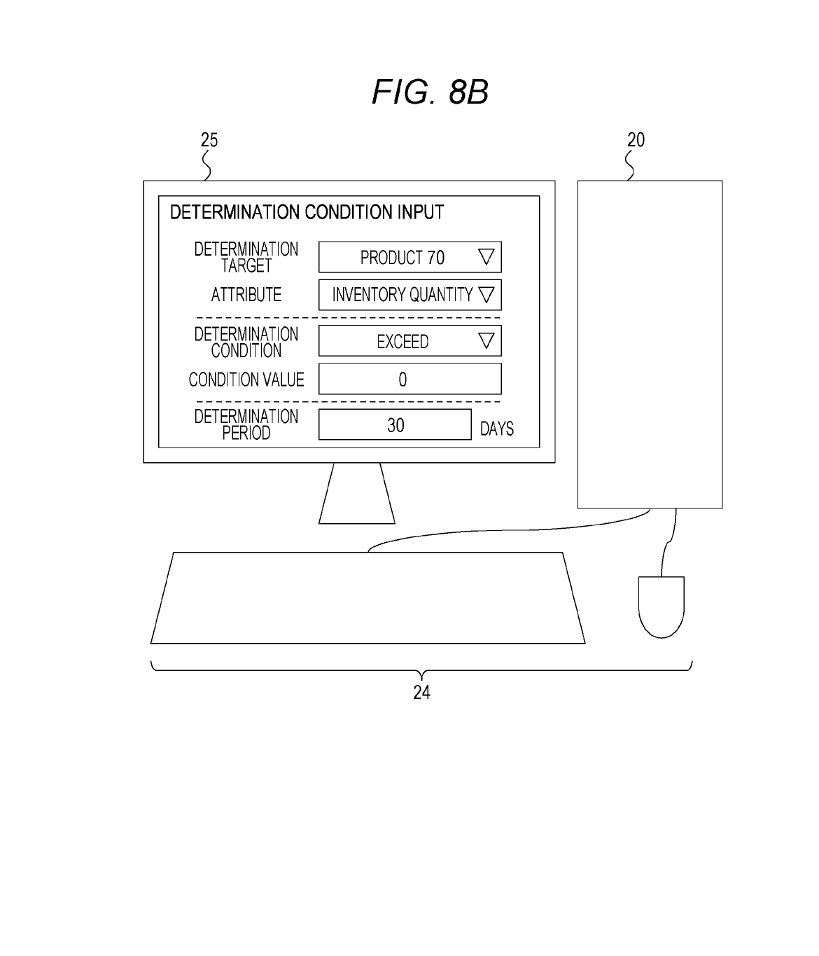

FIG. 8A illustrates a configuration of software functions stored in the storage device 22 of the determination device 20.

An influence notification reception unit 210 receives the influence notification 171 transmitted from the countermeasure plan generation device 10 via the communication medium 30. Then, the content of the countermeasure plan (or identification information for specifying the countermeasure plan) included in the influence notification 171 and the operation level 211 and the continuation risk 212 in the target system 410 when the countermeasure plan is executed are extracted and input to the business continuity determination unit 240.

The demand information acquisition unit 220 acquires demand information 221 regarding the operation continuation from the cooperation destination system 510 and inputs the demand information to the business continuity determination unit 240. The demand information 221 is an index for calculating the business of the second business operator 50, that is, the ability to continue production of a product using the product 70 supplied from the first business operator 40, and includes actual values regarding the inventory amount, the consumption amount, and the consumption interval of the product 70. As a method of acquiring the demand information 221, the demand information may be acquired directly from the cooperation system 510 by sensing, or may be acquired by cooperation with an existing business management system such as a supply chain management system (SCM).

A determination condition input unit 230 provides a function of setting, by the user using the input device 24 or the like, a condition of the demand information 221 for determining that business continuity is possible in the second business operator 50 and a period for performing the condition determination. The condition that the business can be continued is, for example, “a state in which the inventory amount of the product 70 exceeds 0 continues”, “the attack propagation risk from another system is less than a predetermined level”, and the like, and the condition determination period is, for example, “30 days”. The determination condition input unit 230 can be a user interface as illustrated in FIG. 8B using the input device 24 and the display device 25, for example.

With the demand information 221 as an initial state for the cooperation destination system 510, the business continuity determination unit 240 predicts how the demand information 221 transitions within the condition determination period set in the determination condition 231 by a predetermined calculation formula, simulation, or other means based on the operation level 211 and the continuation risk 212. Further, it is evaluated whether the result satisfies the determination condition 231, and the result (business can be continued or cannot be continued.) is output as the business continuity evaluation result 241. When the determination result indicates that the business cannot be continued, an improvement condition for changing the determination result to business continuity may be added in addition to the determination result itself. As the improvement condition, for example, an operation level, that is, the supply amount of the product 70 may be increased, or the continuation risk, that is, the security risk may be reduced.

The determination result transmission unit 250 embeds the business continuity determination result 241 in the determination result notification 251, and transmits the result to the countermeasure plan generation device 10 via the communication medium 30. In a case where the determination device 20 has received a plurality of influence notifications 171, a plurality of business continuity determination results 241 is also generated corresponding to each of the influence notifications 171. Therefore, for example, the identification information (identifier) of the countermeasure plan 131 embedded in the influence notification 171 is embedded in the determination result notification 251 together with the business continuity determination result 241, and the correspondence is clearly indicated.

### Description (2) of Countermeasure Plan Generation Device

The determination result notification 251 from the determination result transmission unit 250 is input to the countermeasure plan selection unit 180 of the countermeasure plan generation device 10 in FIG. 3. The countermeasure plan selection unit 180 uses the business continuity determination result 241 embedded in the determination result notification 251 to determine whether to adopt or not to adopt the countermeasure plan 131. That is, the countermeasure plan 131 having the business continuity determination result 241 of “business can be continued” is acceptable for business continuity of the second business operator 50 when executed in the target system 410, and is adopted as the countermeasure plan 60. Meanwhile, the countermeasure plan 131 having the business continuity determination result 241 of “business cannot be continued” is unacceptable for the second business operator 50, and thus is not adopted.

In a case where there is only one adopted countermeasure plan 131, this is output to the countermeasure plan execution device 420 as the countermeasure plan 60. When a plurality of the countermeasure plans 131 are adopted, one of them is selected and output to the countermeasure plan execution device 420 as the countermeasure plan 60. The selection criteria may be arbitrarily set, but may be set so as to select, for example, the countermeasure plan with the lowest continuation risk 161 in the target system 410 or the countermeasure plan with a higher operation level 151.

When all the received countermeasure plans 131 are not adopted, the countermeasure plan selection unit 180 transmits a regeneration instruction 181 to the countermeasure plan generation unit 130. At this time, hint information for making the plan acceptable for business continuity of the second business operator 50 may be added to the regeneration instruction 181. For example, as described above, the improvement condition added when the business continuity determination result 241 is output from the business continuity determination unit 240 is added as the hint information.

When receiving the regeneration instruction 181, the countermeasure plan generation unit 130 generates a new countermeasure plan 131 in which at least either the countermeasure content or the application time is corrected with respect to the previously generated countermeasure plan 131. At this time, in a case where the hint information is presented from the countermeasure plan selection unit 180, the hint information is used as a reference for correction of the countermeasure content and the application time. For example, when the operation level (that is, the supply amount of the product 70) is excessively low, a measure having a smaller influence on the performance of the target system 410 is selected, or the application time is delayed until the inventory quantity in the cooperation system 510 is secured. In addition, in a case where the continuation risk (that is, the attack propagation risk on the cooperation system 510) is excessive, the countermeasure content is changed to a more powerful countermeasure content or a countermeasure having another content is added.

In a case where a new countermeasure plan 131 is generated by the regeneration instruction 181, the estimation of the influence in the countermeasure plan generation device 10 and the evaluation of the influence in the determination device 20 described above are performed again, and the operation thereof is repeated until the countermeasure plan selection unit 180 adopts the countermeasure plan 131. However, in a case where a countermeasure plan acceptable to the second business operator 50 is not generated even when this repetitive operation is performed a predetermined number of times, for example, by displaying that the determination is left to an administrator from the display device 16 and outputting a countermeasure plan candidate so far, it is possible to prevent the countermeasure from being unnecessarily delayed.

As described above, according to the present embodiment, the influence on the business continuation in the first business operator 40 when the countermeasure plan 131 is applied to the target system 410 and the influence on the business continuation occurring in the second business operator 50 due to the influence are evaluated, and only the countermeasure plan 131 acceptable to the second business operator is adopted and executed. As a result, when the first business operator and the second business operator constitute a supply chain, it is possible to cope with an abnormality such as a cyberattack while suppressing the influence of the supply chain on the continuation of the finally provided product or service.

### Second Embodiment

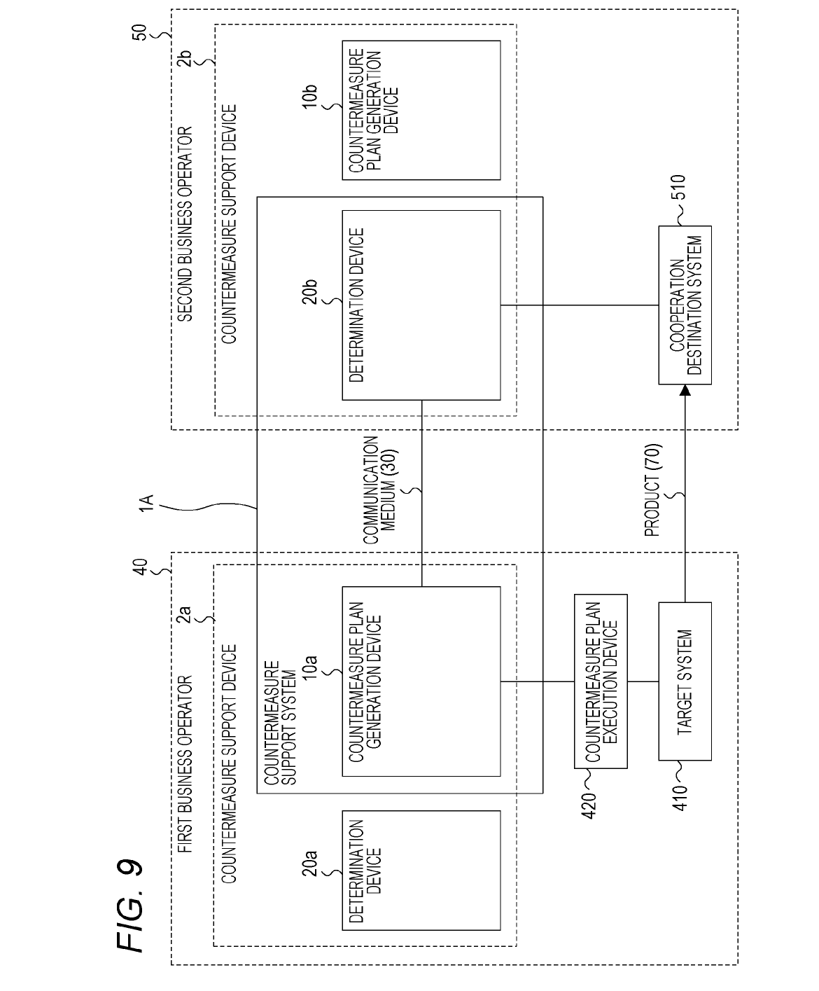

Next, a second embodiment of the present invention will be described with reference to FIG. 9. In the following embodiments, unless otherwise specified, components denoted by the same reference numerals as those in the first embodiment have the same functions, and the description thereof may be omitted.

In the present embodiment, the first business operator 40 and the second business operator 50 have countermeasure support devices 2a and 2b, respectively. The countermeasure support devices 2a and 2b have the same configuration, and the countermeasure plan generation devices 10a and 10b and the determination devices 20a and 20b are mounted in the same device. Among them, the countermeasure plan generation device 10a and the determination device 20b are connected by the communication medium 30 to constitute a countermeasure support system 1A.

The countermeasure plan generation devices 10a and 10b are implemented by using, for example, the hardware of the countermeasure plan generation device 10 (FIG. 2) described in the first embodiment and storing, in the storage device 12, software including the software function (FIG. 8A) of the determination device 20 in addition to the software function (FIG. 3) of the countermeasure plan generation device 10. More specifically, the countermeasure plan generation devices 10a and 10b can be configured by using a PC as hardware and installing package software including the functions of the countermeasure plan generation device 10 and the determination device 20.

With the configuration described above, it is possible to construct the countermeasure support system 1A for the first business operator 40 and the second business operator 50 using the single-configuration countermeasure support devices 2a and 2b. That is, since it is sufficient to manufacture or prepare a single device in a vendor that delivers the countermeasure support system to the first business operator and the second business operator, there is a possibility that delivery time, cost, and the like are reduced as compared with a case where separate devices are designed and manufactured. As a result, it is possible to expect an effect of facilitating introduction of the countermeasure support system for both the business operator and the vendor.

In addition, there is a case where an actual supply chain is formed by participation of more than two business operators, and even in such a case, the countermeasure support system can be configured between all the business operators by introducing the countermeasure support device 2a (2b) having a single configuration to all the business operators according to the configuration of the present embodiment. Specifically, in FIG. 9, the determination device 20a remaining in the first business operator 40 may be connected to a countermeasure plan generation device (not illustrated) introduced to another business operator, or the countermeasure plan generation device 10b remaining in the second business operator 50 may be connected to a determination device (not illustrated) introduced to another business operator. By doing so, it is possible to cope with the supply chain configured by more business operators.

### Third Embodiment

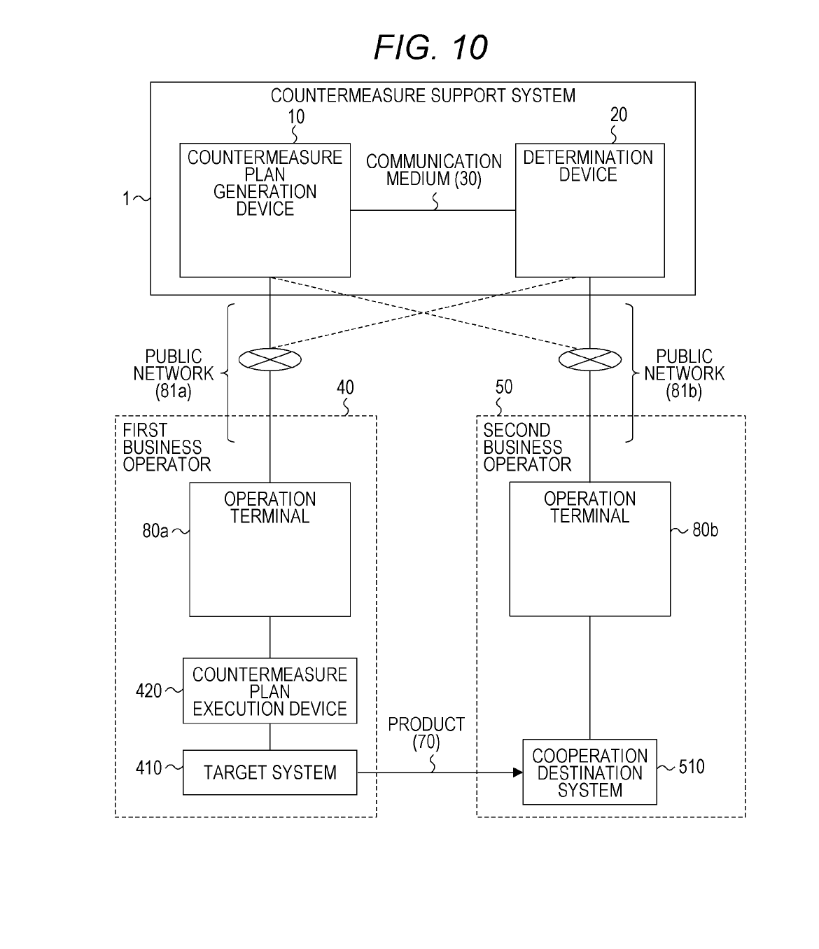

Next, a third embodiment of the present invention will be described with reference to FIG. 10.

In the present embodiment, it is assumed that both the countermeasure plan generation device 10 and the determination device 20 constituting the countermeasure support system 1 are installed in a place different from the target system 410 and the cooperation destination system 510, for example, in a server room or a data center.

An operation terminal 80a is connected to the target system 410, an operation terminal 80b is connected to the cooperation destination system 510, and the operation terminals 80a and 80b are connected to the countermeasure plan generation device 10 and the determination device 20 via public networks 81a and 81b such as the Internet, respectively. The operation terminals 80a and 80b can be connected to the countermeasure plan generation device 10 and the determination device 20, and which one of them is connected is determined by the role between the business operators. When the second business operator 50 is the supplier and the first business operator 40 is the supply destination, the connection path indicated by the dotted line is selected (in this case, the countermeasure plan execution device 420 and the target system 410 are arranged in the second business operator 50, and the cooperation destination system 510 is arranged in the first business operator 40).

Both the operation terminals 80a and 80b can be realized by a PC or the like similarly to the countermeasure plan generation device or the like in FIG. 2, and functions to be mounted include an interface function with the user and a communication relay function between the countermeasure plan generation device 10 or the determination device 20 and the countermeasure plan execution device 420 and the target system 410 or the cooperation destination system. In addition, the operation terminals 80a and 80b include an input device and a display device (not illustrated), which replace the input device 15 and the display device 16 included in the countermeasure plan generation device 10 and the display device 25 included in the determination device 20 in the first embodiment and the input device 24, respectively.

Note that the communication medium 30 is not limited to the local network, and can be realized by the public networks 81a and 81b.

With the above configuration, it is possible to simplify the device connected to the target system and the cooperation destination system, and it is possible to reduce the space required for introduction of the system and the demand for power supply and the like. In addition, since the function improvement and the modification of the countermeasure support system 1 can be performed at a remote place, it is possible to reduce the burden on the business operator who uses the countermeasure support system 1.

### Fourth Embodiment

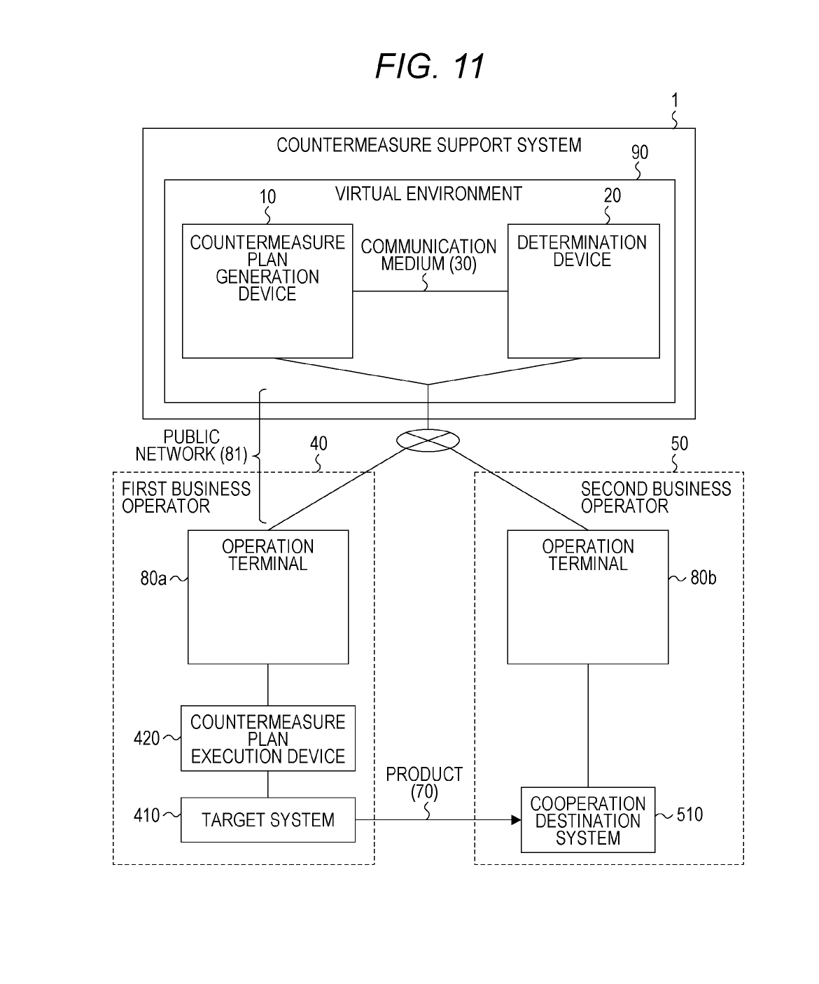

Next, a fourth embodiment of the present invention will be described with reference to FIG. 11.

The present embodiment is a modification of the third embodiment, and the basic configuration and function are the same. The fourth embodiment is different from the third embodiment in that the countermeasure plan generation device 10 and the determination device 20 are mounted on a virtual environment 90. The virtual environment 90 is an execution environment that is constructed by a virtual machine, a container, or a technology similar thereto and can simulate a plurality of devices.

As in the third embodiment, the virtual environment 90 is installed in a server room, a data center, or the like that is away from the target system 410 and the countermeasure plan execution device 420. The communication medium 30 may be any of a virtual network on the virtual environment 90, a local network connected to the virtual environment, and a communication path set on the public network 81.

In addition to the effects of the third embodiment, in the present embodiment, the entire countermeasure support system 1 is virtualized. Therefore, when it is difficult to continue the operation of the execution environment due to a disaster or the like, the continuation of the execution can be ensured by moving across data centers, backing up, or the like. As a result, even when the supply chain is disrupted due to the disaster or the like, the support can be continued.

Note that the present invention is not limited to the above-described embodiments, and includes various modifications. For example, each of the above-described embodiments has been described in detail in order to describe the present invention in an easy-to-understand manner, and the present invention is not necessarily limited to those having all the described configurations. In addition, within a possible range, a part of the configuration of a certain embodiment can be replaced with the configuration of another embodiment, and the configuration of another embodiment can be added to the configuration of a certain embodiment. In addition, it is possible to add, delete, and replace other configurations to a part of the configuration of each embodiment within a possible range.

What is claimed is:

1. A countermeasure support system comprising a countermeasure plan generation device and a determination device, wherein
the countermeasure plan generation device includes
an input unit that generates event information regarding an event that occurs in a target system that is a target for which a countermeasure plan of the countermeasure plan generation device is to be created,
a system model generation unit that generates a system model expressing an operation of the target system,
a scenario generation unit that generates an event scenario of the event for the target system by using the event information and the system model,
a countermeasure plan generation unit that generates a countermeasure plan for the event by using the event scenario,
an operation prediction unit that predicts an operation of the target system using the system model, the event scenario, and the countermeasure plan,
a first influence evaluation unit that evaluates a first influence on the target system using an operation prediction result by the operation prediction unit, and
a first transmission unit that transmits the countermeasure plan created by the countermeasure plan generation unit and a first evaluation result by the first influence evaluation unit to the determination device, and
the determination device includes
a reception unit that receives the countermeasure plan and the first evaluation result transmitted by the first transmission unit,
a second influence evaluation unit that uses the countermeasure plan received by the reception unit and the first evaluation result to evaluate a second influence of the first influence on a cooperation destination system that cooperates with the target system, and
a second transmission unit that transmits a second evaluation result by the second influence evaluation unit to the countermeasure plan generation device.

2. The countermeasure support system according to claim 1, wherein
the first influence evaluation unit evaluates an operation level that is a lapse of time of production capacity of the target system in response to the event and a continuation risk regarding business continuity of the target system based on a transition of the operation level, and
the second influence evaluation unit evaluates an influence on production continuity of a product in the cooperation destination system by using the operation level and the continuation risk in the first influence evaluation unit.

3. The countermeasure support system according to claim 1, wherein
the countermeasure plan includes any one of an implementation content of a countermeasure, an application place of the countermeasure, and an application time of the countermeasure.

4. The countermeasure support system according to claim 1, wherein
the countermeasure plan generation device includes a countermeasure plan selection unit that determines either adoption or modification of the countermeasure plan based on the second evaluation result.

5. The countermeasure support system according to claim 4, wherein
when receiving an instruction to modify the countermeasure plan from the countermeasure plan selection unit, the countermeasure plan generation unit modifies at least one of an implementation content of the countermeasure plan and an application time of the countermeasure plan.

6. A countermeasure support system comprising a plurality of countermeasure support devices in which the countermeasure plan generation device and the determination device according to claim 1 are mounted in the same device, wherein
in one of the countermeasure support devices, the countermeasure plan generation device is connected to the target system, and
in another of the countermeasure support devices, the determination device is connected to the cooperation destination system.

7. A manufacturing system comprising:
the countermeasure support system according to claim 1;
the target system;
the cooperation destination system; and
a countermeasure plan execution device that reflects the countermeasure plan generated by the countermeasure plan generation device in the target system.

8. A manufacturing system comprising:
the countermeasure support system according to claim 6;
the target system;
the cooperation destination system; and
a countermeasure plan execution device that reflects the countermeasure plan generated by the countermeasure plan generation device in the target system.

9. The manufacturing system according to claim 7, comprising a first operation terminal connected to the countermeasure plan execution device and a second operation terminal connected to the cooperation destination system, wherein
the first operation terminal and the second operation terminal are connectable to any one of the countermeasure plan generation device and the determination device via a public network.

10. The manufacturing system according to claim 9, wherein
the countermeasure plan generation device and the determination device are arranged in a virtual environment.

11. A countermeasure support method comprising:
an input process of generating event information regarding an event that occurs in a target system that is a target for which a countermeasure plan is to be created;
a system model generation process of generating a system model expressing an operation of the target system;
a scenario generation process of generating an event scenario of the event for the target system by using the event information and the system model;
a countermeasure plan generation process of generating a countermeasure plan for the event by using the event scenario;
an operation prediction process of predicting an operation of the target system using the system model, the event scenario, and the countermeasure plan;
a first influence evaluation process of evaluating a first influence on the target system using an operation prediction result by the operation prediction process and outputting the first influence as a first evaluation result; and
a second influence evaluation process of evaluating a second influence of the first influence on a cooperation destination system cooperating with the target system by using the countermeasure plan and the first evaluation result.
